(19) United States
(12) Patent Application Publication
(10) Pub. No.: US 2024/0149812 A1
(43) Pub. Date: May 9, 2024

(54) AUTOMOTIVE NETWORK ZONED ARCHITECTURE WITH FAILURE MITIGATION FEATURE

(71) Applicants: Vitesco Technologies GmbH, Regensburg (DE); Continental Automotive Technologies GmbH, Hannover (DE)

(72) Inventors: Ludwig Ramsauer, Munich (DE); Rainer Knorr, Munich (DE)

(21) Appl. No.: 18/275,313

(22) PCT Filed: Feb. 14, 2022
(86) PCT No.: PCT/EP2022/053552

§ 371 Date: Aug. 1, 2023

(30) Foreign Application Priority Data
Feb. 15, 2021 (GB) 2102080.5

(51) Int. Cl. B60R 16/033

(52) U.S. Cl. CPC B60R 16/033

(57) ABSTRACT

An electrical power supply network for a set of power-consuming nodes with a Failure Mitigation feature is disclosed. The network has two or more zones, a zone comprises two or more electrical power consuming nodes, and at least one Power Switch which controls the entry and exit of electrical power to the zone. In the event of partial or complete failure of the power supply network, power is redistributed between nodes of a zone. An “Emergency trigger” may cause execution of “Last Commands” to keep and/or execute a safe state.

### CROSS REFERENCE TO RELATED APPLICATIONS

This application is the U.S. National Phase Application of PCT International Application No. PCT/EP2022/053552, filed Feb. 14, 2022, which claims priority to Great Britain Patent Application No. 2102080.5, filed Feb. 15, 2021, the contents of such applications being incorporated by reference herein.

### FIELD OF THE INVENTION

The instant disclosure relates to a power supply architecture for a network of electrically operated zones which are used in an automotive environment. It may be desirable that zones of a network, such as nodes, Electronic Control Units or collections of Electronic Control Units (ECU) which may form the zones of a network in an automobile, be continuously ensured of a usable power supply, despite the fluctuations which are often typical of an automotive environment.

### BACKGROUND OF THE INVENTION

Automotive vehicle manufacturers (OEM's) and Tier-1 suppliers to the automotive industry continue to develop new architectures for automotive controllers or electronic control units (ECU's/nodes)). One development is the so-called “Zone-Oriented Architecture”, in which nodes co-located in a physical installation location are connected to a “Zone ECU”, e.g. such as a front-right-door zone. The Zone ECUs are connected to a central server, i.e. nodes are not, or not always, connected directly and physically to other nodes, but rather via Zone ECUs and central servers using communication or data channels. Zones themselves may comprise groups of nodes, being primarily co-located nodes, or nodes with related functionality, or both.

A challenge with an automotive network, is to ensure that all zones which are active or wish to communicate, have a power supply which supplies sufficient electrical power. This applies particularly to Zone ECUs which have a safety-relevant function, e.g. steering or brakes. The power must be of sufficient voltage and current, and “clean” or free enough of disturbances that the given zone and/or its nodes can operate correctly and reliably.

There are many factors, especially in an automotive environment, which may make it difficult to ensure a “clean” supply. Some consumer nodes such as a starter motor or a PTC heater may use an amount of power which is an order of magnitude or orders of magnitude greater than what another single node such as an interior light may use. Power may at times be supplied from a battery, which may not be fully charged, or which may have a reduced capacity due to age, low temperatures, etc. Failure is another factor, where a supply cable or supply connector may partially or completely fail. The failure may impact Zone ECUs and/or standalone nodes.

In addition, the electrification of automotive functions such as braking and steering means that certain nodes must be given a higher priority if the amount of electrical power is limited. For example, if not enough power is available, an electrical seat heating must be given a lower priority than electrical steering. This in turn means that the supply architecture must be able to prioritize certain zones or, within the zone, certain nodes, such that they continue to receive power and be able to operate and communicate, even while other zones or within a zone certain nodes are gracefully disabled. In such a way, the effect of partial or complete failure can be mitigated. The same holds true for stand-alone nodes without a corresponding Zone ECU.

A centralized architecture—for example a single power bus—must be designed to carry all simultaneously needed electrical power. If available power is limited, then each individual zone must disconnect itself if it is of lower priority. In addition, a single zone failure can mean a catastrophic failure for the whole power supply, e.g. if a zone develops a short circuit.

Redundant power supplies might be used to supply power to high-priority zones such as safety-critical zones. DC/DC converters might be used to ensure a sufficient operating voltage in the face of voltage drops in the supply. However, such an architecture may bring increased cost, complexity, and weight. Dynamic reconfiguration also becomes complex with an architecture that includes redundant supply paths and converters.

Another possibility is a ring structure with different supply zones (see patent DE10317362, which is hereby included by reference).

Therefore, there is a need for an improved power supply architecture, which redistributes power to zones and nodes of differing priority, such that safe operation can be ensured to the extent possible. The architecture must be robust against faults, and must be easily reconfigured without requiring overly complex support circuitry.

### SUMMARY OF THE INVENTION

An aspect of the invention relates to an electrical power supply network for a set of power-consuming nodes, comprising two or more zones, wherein at least one zone preferably comprises two or more electrical power consuming nodes, and preferably at least one Power Switch which controls the entry and exit of electrical power to the zone. It may be implemented, that in the event of failure of the power supply network, power is redistributed between nodes of a zone and/or between zones.

The failure may especially be a partial failure. Especially, each zone may comprise two or more nodes, and/or some nodes or each node may be part of a respective zone. Also, more than one zone, or all zones, may each comprise two or more electrical power consuming nodes. In addition, there may be one or more zones with only one node. They may otherwise be embodied as zones with two or more nodes.

According to a possible implementation, one type of failure is a failure in a power source supplying electrical power to the network.

According to a possible implementation, one type of failure is an interruption of an electrical connection forming the network and/or being part of the network.

Especially, these electrical connections may be used to distribute power between components of the network.

According to a possible implementation, one type of failure is an interruption in communication between nodes and/or between zones. For such communication, implementations like special lines and/or bus systems may be used.

According to a possible implementation, power is redistributed by disconnecting one zone, or more than one zone, from the network. Disconnecting a zone may especially mean that the zone, while disconnected, does not receive power using the network. It can, for example, deactivate its nodes, and/or can use a local power supply while disconnected, for example a local power supply like a local buffer or a local electricity store as described herein.

According to a possible implementation, power is redistributed depending on the type of failure.

According to a possible implementation, one or more nodes are standalone nodes not being part of a zone. Such standalone nodes may be present in addition to zones each comprising two or more nodes.

According to a possible implementation, one or more zones, or each zone, each comprise at least one Zone ECU. The Zone ECU may perform different tasks, for example for controlling a zone and/or for communicating with other zones, standalone nodes, and/or a server.

According to a possible implementation, the Power Switch is configured to either disconnect or connect nodes of a zone with the rest of the network. While connected, a zone may receive power from a central power supply using the network. While not connected, such power reception may be interrupted.

According to a possible implementation, electrical connections between zones are at least in part, or fully, in the form of a ring. For example, each zone may be connected with exactly two other zones, with exactly one standalone node and one zone, or with two standalone nodes, in order to form a ring. The same may be true for standalone nodes.

According to a possible implementation, the network comprises multiple rings of zones or Power Switches. Thus, the ring concept may be scaled by using more than one ring.

According to a possible implementation, in the event of failure of the power supply network, zones, Zone ECUs, standalone nodes and/or a central server communicate amongst themselves and/or between each other, especially to determine the redistribution of power. For example, such a communication may lead to an arbitration between the communicating components.

According to a possible implementation, a central server sends individual “Last Commands” to zones, Zone ECUs and/or standalone nodes.

According to a possible implementation, a “Last Command” is sent in response to determining at least one type of failure, or in response to determining a failure.

According to a possible implementation, a “Last Command” depends on a type of a detected failure.

According to a possible implementation, a central server, zones, Zone ECUs and/or standalone nodes are connected via an “Emergency Trigger” line.

According to a possible implementation, the “Emergency Trigger” line is partly or fully connected as a ring.

According to a possible implementation, some or all components connected to the “Emergency trigger” line will execute the “Last Command” action or actions in case of an interrupted communication, an interrupted communication over the “Emergency Trigger Line”, and/or an active “Emergency Trigger”.

According to a possible implementation, the active “Emergency Trigger” is sent using the “Emergency trigger” line.

According to a possible implementation, the nodes of a zone execute a Last Command in the event of a failure of the power supply network.

According to a possible implementation at least one zone comprises a local buffer or local electricity store.

According to a possible implementation, the local buffer or local electrical store comprises, or is embodied as, a battery, or a capacitor, and/or other electrical supply or storage devices.

According to a possible implementation, a given zone, one zone, or more than one zone, or each zone, is configured to, in the event of failure, receive power from the local buffer or local electricity store of another zone, and/or from recuperation energy from a drive or traction motor.

According to a possible implementation, the local buffer or local electricity store is configured to supply additional power for a zone which does not have a local buffer and/or does not have a local electricity store and/or has an insufficient local store. An insufficient local store may especially be characterized by a loading state of a battery, capacitor, or other storage means being below a specified threshold.

According to a possible implementation, power is redistributed by supplying power from a local buffer and/or a local electricity store to one node or more nodes of the same zone as the local buffer and/or the local electricity store.

According to a possible implementation, power is redistributed by supplying power from a local buffer and/or a local electricity store to one node of more nodes of a different zone as the local buffer and/or the local electricity store.

According to a possible implementation, at least one zone comprises a sub-zone.

According to a possible implementation, the network is adapted for use in an automotive environment.

An aspect of the invention relates further to a method of operating an electrical supply network comprising two or more zones, wherein, in the event of failure of the power supply network, power is redistributed between nodes of a zone, and/or between zones.

According to a possible implementation, in the event of a failure, the Zone ECU of a zone and/or nodes of a zone determine, or communicate amongst themselves and/or with each other to determine, which node or nodes receive power. Possibly, other nodes do no longer receive power. This may be implemented by suitably switching power switches or other elements.

According to a possible implementation, the nodes pass electricity around a ring.

According to a possible implementation, in the event of failure, peak consumption of local consumers from the central power supply is reduced and/or the consumption from the central supply to closer to that of an average load is limited.

According to a possible implementation, the method is performed using a network as disclosed herein. With regard to the network, all disclosed implementations and variations can be applied.

In embodiments of the invention, nodes are connected to Zone ECUs by position, e.g. position in a vehicle. In one aspect of the invention, redundancy against failures may be provided using supply connections in a ring or by redundant supply connections. In another aspect, the supply architecture is designed for a typical load of consumers or nodes; zones may have a local power supply for the zone, and nodes may have a relatively constant power consumption.

In another aspect of the invention, a node or even whole Zone ECU can be turned on or off, connected or disconnected from a central power supply with a Power Switch, either under local zone control or by direction from a central controller, for example to redistribute power. In an additional aspect, a Zone ECU may have an adaptive power consumption whereby the power consumption is reduced by providing a reduced functionality. The reduction may begin with nodes for comfort functions, and proceed to an absolute minimum consumption by only nodes for safety-relevant functions. The power consumption reduction, or the power consumption, may be achieved by turning off selected nodes, or by reducing the power consumption of one or more nodes in a zone.

It should be noted that the claimed method can especially be performed using the claimed network. Furthermore, the claimed network can be configured to perform the claimed method. All respective embodiments and variations as disclosed herein can be applied.

The nodes may communicate with the Zone ECU and/or the central server, to determine which nodes in a zone can most easily reduce power consumption, or which nodes can be turned off without a risk to safe operation of a vehicle. The zones may communicate to determine a relative priority, or there may be a fixed or pre-established priority scheme to determine which zones and which nodes reduce their power consumption.

In another aspect of the invention, each zone may have a local energy source or energy store or load buffer. A zone may cover peak consumption of local consumers from the central power supply, or the zone may limit consumption from the central supply to its average load (load levelling). In one aspect a zone may operate autonomously without or with less power from the central supply, using a local buffer or local electrical store. The local store may be dimensioned to cover peak loads beyond the average use, or to cover a fixed portion of the peak loads. The local store may be dimensioned to allow the zone to continue functioning in the case of a central power supply failure until a vehicle may be brought into a fail-safe or “safe shutdown” state. Those features may be regarded as separate inventive aspects that can be implemented independently from other features or implementations disclosed herein.

In one embodiment, a Zone ECU may have the capability to measure loading or load, to continuously observe loading, and/or to predict expected future loading. Likewise, a Zone ECU may have or be assigned a central controller which enables decision-making and controlling of the Zone ECU. Decision-making and controlling of the nodes connected to a Zone ECU may also be distributed amongst some or all of the nodes in a zone, or may be shared between a central controller and Zone ECU.

Information about the topology of a power supply network of a vehicle, i.e. the connectivity structure of the controller network and the information on data to be exchanged, may be provided manually or statically at a single point in time, during or after configuration of the vehicle. This topology information may be taken as a given, i.e. from the manufacturer. However, the growing complexity and diversity of variants in automotive production makes a static approach to topology information for each production car less efficient and less desirable. Topology may be determined dynamically by dynamic software or individual applications. An aspect of the instant invention can be used to support a dynamic topology capability.

### BRIEF DESCRIPTION OF THE DRAWINGS

Aspects of the invention are best understood with reference to the figures, as described below.

FIG. 1 shows a “Zone Architecture”.

FIG. 2 shows a Power Switch and Power Switch module for a zone.

FIG. 3 shows the communication adapter for a zone.

FIG. 4 shows typical components of a zone.

FIG. 5 shows an example of the inventive concept in an automotive application.

FIG. 6 shows main communication channels between Zone ECUs and a central server, with an emergency trigger line.

FIG. 7 shows steps of failure mitigation.

### DETAILED DESCRIPTION OF THE PREFERRED EMBODIMENTS

The detailed description set forth herein is meant to give the person of skill an understanding of certain implementations of an aspect of the instant invention.

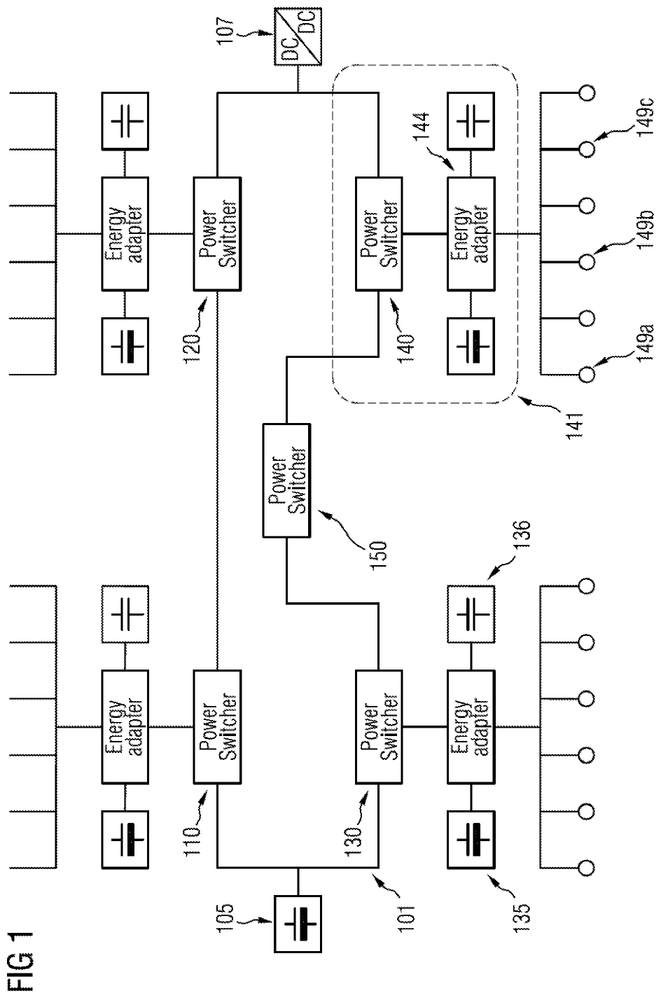

FIG. 1 shows an example of an automotive zone architecture. Power Switches 110, 120, 130, 140, 150 are connected to central power supplies as a battery 105 and a DC-DC converter 107 in a ring topology 101. The Power Switches are part of respective zones 141 (exemplary), which comprise Energy Adapters 144 and optionally a battery 135 and/or a capacitor 136 and/or other electrical supply or source or storage devices. The Module 141 provides electrical power from the power ring 101 to consumer nodes 149a, 149b, 149c (exemplary).

One of the multiple zones in this architecture comprises the Power Switch Module 141 and the nodes 149a, 149b, 149c. The nodes 149a, 149b, 149c may communicate amongst each other and with the Power Switch 140. Likewise, all other zones in this architecture may each comprise a Power Switch Module and nodes, communicating amongst each other and with the respective Power Switch. However, it may also be implemented that only a subset of zones in a network comprise a Power Switch Module and/or take part in power redistribution.

It should be noted that a zone may also comprise more than one Zone ECU and/or more than one power switch. The functionality of one such element can thus be distributed over several such elements. In addition, it is possible to have several such elements for redundancy.

The Energy Adapter 144 together with at least one of a capacitor 136 or a battery 135 forms a local buffer or local electricity store. A zone such as that with elements 140-149c may cover peak consumption of the local consumer nodes 149a-149c from the central power supply connection 101, or the Power Switch 140 of the zone may limit consumption from the central supply to the average load of the zone, i.e. it performs load levelling. In one aspect of the invention, the load levelling may level the load to within 120% of the long-term average load, or some other percentage of long-term average load. In one aspect a zone may operate autonomously without or with less power from the central supply, using the local buffer or local electrical store such as a battery 135 or a capacitor 136. The local store may be dimensioned to allow the zone to continue functioning in the case of a central power supply transient event (e.g. over-/undervoltage due to engine crank, etc.) or failure until either the transient event is over or failure is isolated and the central power supply can be reconnected or a vehicle may be brought into a fail-safe or “safe shutdown” state, i.e. the zone is “fail-operational” for a limited time using the local buffer. The features and implementations disclosed in this section may be implemented separately from other features and implementations disclosed herein. The features and implementations of this section may be regarded as a separate aspect of the invention. Especially, they may be implemented without power redistribution.

In a distributed system, the nodes 149a, 149b, 149c may each be capable of determining a failure condition. When a zone determines that there is a failure condition, it starts failure mitigation by communicating this to some or all other zones, standalone nodes, and to the central controller. The Zone ECU and/or a central server then determine which nodes must be prioritized in order to mitigate failure. The determination may be based on safety considerations. The determination may be based on which nodes are currently actively performing operations, or which have upcoming operations. The determination may be based on a schedule or list of which nodes should reduce consumption in the event of failure. The determination may be based on respective priorities given to each node. It may be implemented that a node may be deactivated sooner the lower its priority. This may be performed with all nodes and/or inside a respective zone. The determination may also use a combination of the above factors.

Alternatively, in a centralized system the Zone ECU or another central controller may determine that there is a partial or complete failure of power for the zone or in another zone. An aspect of the invention also contemplates using a combination of the distributed and centralized approaches described above.

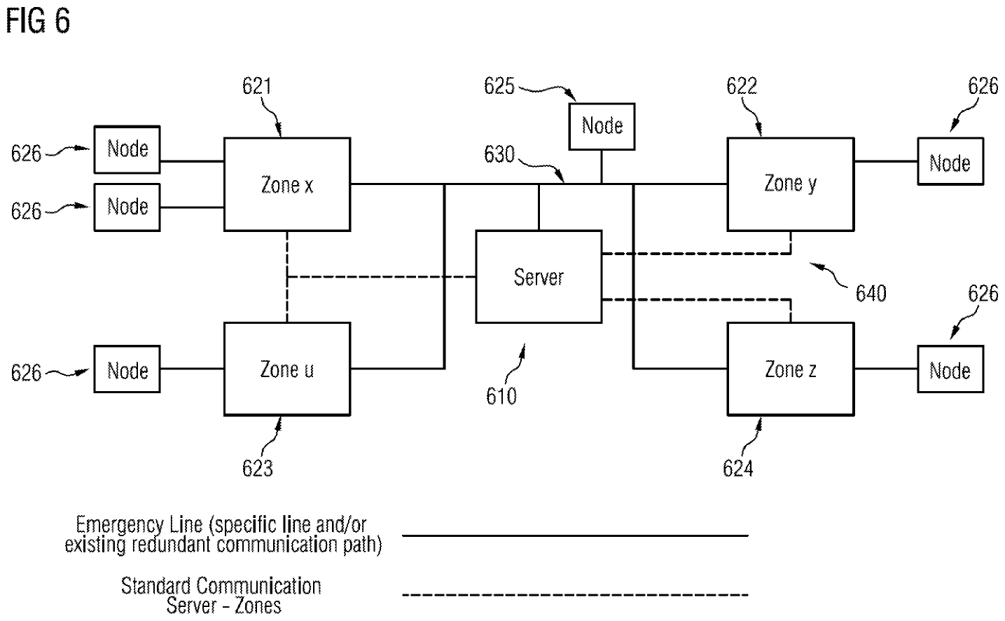

A central server 610, which is shown in FIG. 6, may send periodically or event driven and depending on vehicle mode or status, an individual “Last Command” to each Zone ECU. This “Last Command” indicates one or multiple activities which components shall execute after losing communication. The central server may also send an ‘active’ “emergency trigger”. The “Last Commend” may especially be regarded as a commend setting components in a state that the vehicle may drive safely despite a failure. It can, for example, lead to a deactivation of non-essential nodes or functions.

An example of a Zone ECU 624 is shown in FIG. 6. If a Zone ECU 624 or standalone node with safety-relevant consumers or functions loses contact with the other zones and/or the central server, according to general safety principles, the vehicle is to be brought into safe condition quickly. The activation can be done by using an “Emergency Trigger” 630. This Emergency Trigger may be an additional channel or signal line that connects Zone ECUs, standalone nodes and the central server, for example via a line or ring (similar to Inter-Lock for HV (high-voltage) vehicles). If the signal is ‘active’, it is the signal that the vehicle is to be transferred to the safe state. If there is no communication with the other zones and/or servers, the affected Zone ECUs and dedicated nodes will now execute a “Last Command” or set of operations to mitigate failure. As long as the ring or line remains inactive (for example at high potential—due to robustness considerations), no “Last Command” is run, and normal operation continues.

If the other zones continue to communicate with each other or/and servers, the priority is to reach a safe state. e.g. all functioning zones may wait for further instructions from a central controller.

The signal can be sent by the central server itself, e.g. if caused by major damage, or from a Zone ECU and/or standalone nodes connected to the “Emergency Trigger” without communication. Using an Emergency Trigger, all zones are informed about a Last Command activation, which means that failure mitigation and energy saving measures can occur in all zones simultaneously. For example, a door control unit as a zone can switch off the connected consumers such as mirror heating, ambient light etc. when the Last Command is triggered by the Emergency Trigger, and deactivate the door lock to allow the vehicle to open when it stops.

The remaining, communicatively-reachable zones can be controlled each in such a way that the Last Command is executed optimally (e.g. convenience, accuracy, sequence and speed). Each Zone ECU or standalone node connected to the “Emergency Trigger” may have information on how to react to the Last Command.

In embodiments it may be ensured that a partially defective zone can actually still execute the Last Command. In this case, the zone may still be capable of operation, but communication between the sender of the signal and the zone is not possible. In other words, the zone is still working but cannot get any new data. If the function of the zone is relevant for stopping the vehicle, the server can inform all intact zones that a load command is coming which is not to be executed by the remaining zones reachable by the communication. Only the faulty zone will attempt to execute the Last Command, e.g. if its functions contribute to a stop of the vehicle as soon as the signal is sent from the central controller.

If a central server becomes aware of the loss of one or more security-related Zone ECUs and/or standalone nodes, the central server can still decide on a “Limp Home” if the necessary functions for a continued journey are available despite the zone failure or failures. The central server will then not send the Emergency Trigger for the Last command but only the Limp Home signal. This might be the case, for example, where a Zone ECU may have safety-relevant consumers connected to it, but these consumers are not necessary in the current driving situation. For example, light functionality when it is daytime, and there is no tunnel, etc., on the route.

All functions not required for the driving task may be reduced or degraded by the Last Command in the event of a fault or failure. This allows further optimization of the size of energy storage needed in a zone of a Zone ECU. In an embodiment it may be important that a zone can separate itself from the ring or other principal power supply structure in order to avoid negative effects or energy-loss effects of faulty zones on other zones, and/or to redistribute power.

Another aspect is a distributed arrangement of energy storage devices. A zone-based approach allows only average power supply to be required from the rest of the on-board power supply, since the maximum power is covered by the onsite energy storage devices and these may also provide the necessary temporary average power in the event of failure. Thus an element of the distribution system, the harness, can be significantly reduced in cross-section.

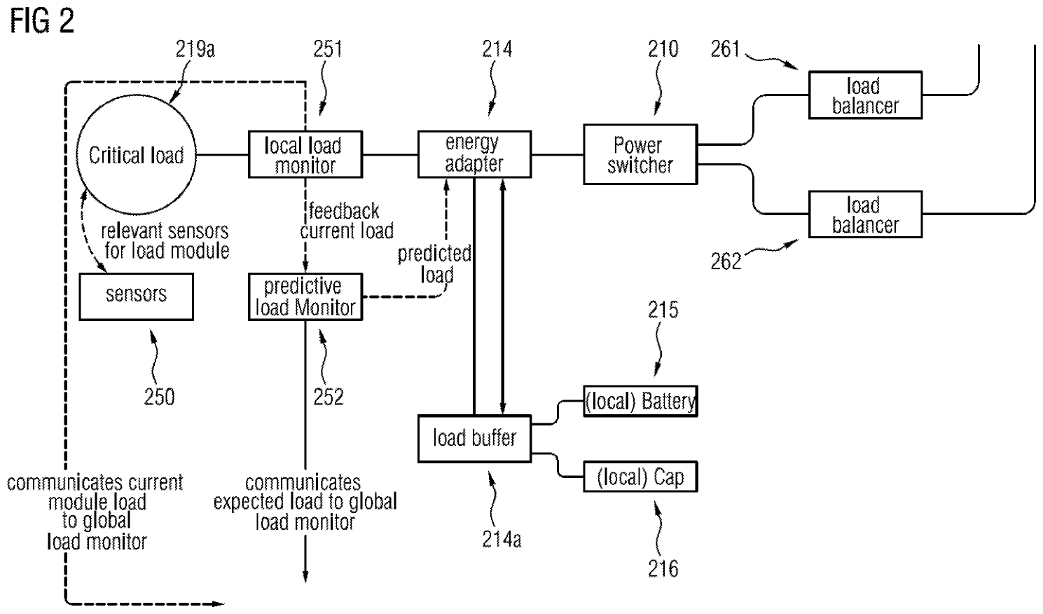

FIG. 2 shows another aspect of the inventive concept. A module may have the capability to measure loading or load in the zone. Each zone may continuously observe loading e.g. with sensors 250 and local load monitor 251, and/or predict expected future loading at 252. The module may have the capability to measure instant loading, to continuously observe loading, and/or predict expected future loading. Likewise, each zone module may have or be assigned a central controller which enables decision-making and controlling of the zone.

This may be implemented in the Power Switcher 140, the energy adapter 144, or in a portion of a central controller (not shown), or a combination of any one of these. In FIG. 2, the power switcher 140 is denoted by reference sign 210, and the energy adapter 144 is denoted by reference sign 214.

The energy adapter 144 may be adapted to handle load excursions such as a peak load situation. It may provide a power boost or “smoothing” of the supply. In particular, it may direct the loading and unloading of electrical energy in the load buffer. It may also hold a current status of the local battery 215 or capacitor 216. It may communicate with and cooperate with the load buffer to load the local battery and/or capacitor as appropriate.

The load buffer 214a may be separate or may be integrated with other elements such as the energy adapter 214. It provides a local power buffer for critical loads, using battery or capacitor or both. It covers load peaks or above average loads, but for a limited time. An additional aspect may be a capability to provide a short-term power supply in the case of a complete or partial loss of system power. This may include a support function to enable “fail-operation” capability, for example Last Command execution for safety functions. The load buffer may also be dimensioned for long-term power supply, especially if this can be provided without excessive cost, weight, size, etc.

In an aspect of the invention, that can be combined with other aspects but can also be regarded as a separate aspect, the local load buffer 214a and storage device or devices such as battery 215 or capacitor (cap) 216 of a given zone (e.g. 135, 136) may be charged from different sources. The local store may be charged via ring 101 from a central power source, or from the local buffer or store of another zone, or from recuperation energy (e.g. from a drive or traction motor), or from a combination of these.

Likewise, in another aspect of the invention, that can be combined with other aspects but can also be regarded as a separate aspect, a given zone may obtain power for distribution to attached nodes from different sources. The zone may receive power from a central power source such as 105 or 107, or from the local store of another zone, or from recuperation energy (e.g. from a drive or traction motor), or from a combination of these, and/or to redistribute power.

The local store of a given zone, 135 and/or 136 may also supply electrical power to a central supply such as battery 105, for example to cover the needs of peak loads, or to supply additional power for a zone which does not have a local store. In other words, the local store of one zone may (at least partially) function as a local store for another zone.

The Power Switch 210 may be connected via the ring to load balancers 261, 262. Load balancers may comprise high-frequency filters such as small capacitors. The load balancers may be distributed across the ring and operate autonomously to improve the quality of the power supply.

Autonomous operation in the event of failure may be critical for autonomous vehicles. The zone with all its nodes or loads may be self-sufficient or partially self-sufficient. For example, the zone may have a local store as an energy storage device capable of supplying the loads in the event of failure, at least until the vehicle is in a safe state or until the driver has taken control of operation.

In embodiments, the zone is energy as well as functionally self-sufficient, where the zone also has a Zone ECU control unit which may include, or may be embodied as, or may be present in addition to the Power Switch 210 that takes over the local control and controls the directly-connected loads and sensors.

The availability of other functionalities, which may be still fully functional connected to a central control unit, can still be partly supported. For example, headlight control might still be activated independently, and this ensures the function of the camera for object recognition even in darkness.

The vehicle's standstill management, which may have a target to be reached within 10-15 minutes, even for highly automated vehicles, can also be supported through improved failure mitigation.

If there is no communication to the zone, the zone may operate according to the principle “Last Command”. In embodiments, actuators may be controlled in a zone in a way that would be necessary for the safe condition of e.g. stopping the vehicle. For example, a steering system located in the zone may select the last known free path for the vehicle and follow that. In this example, the zone contains the last GPS data and the planned route of the vehicle. This is particularly important if the vehicle is on a motorway etc. and cannot stop immediately. In general, a zone always receives the necessary information for driving commands, and in particular for the driving order “Last Command”, the zone must ensure reaching a safe condition, e.g. “stop”. The vehicle may transfer to a “limp home” state, e.g. a reduced speed. This allows for using existing data to achieve a time-limited, extended availability of functions and thus a time-limited continuation of safe driving. Functions may be downgraded, but the safe condition of “stopping” driving must still be achieved.

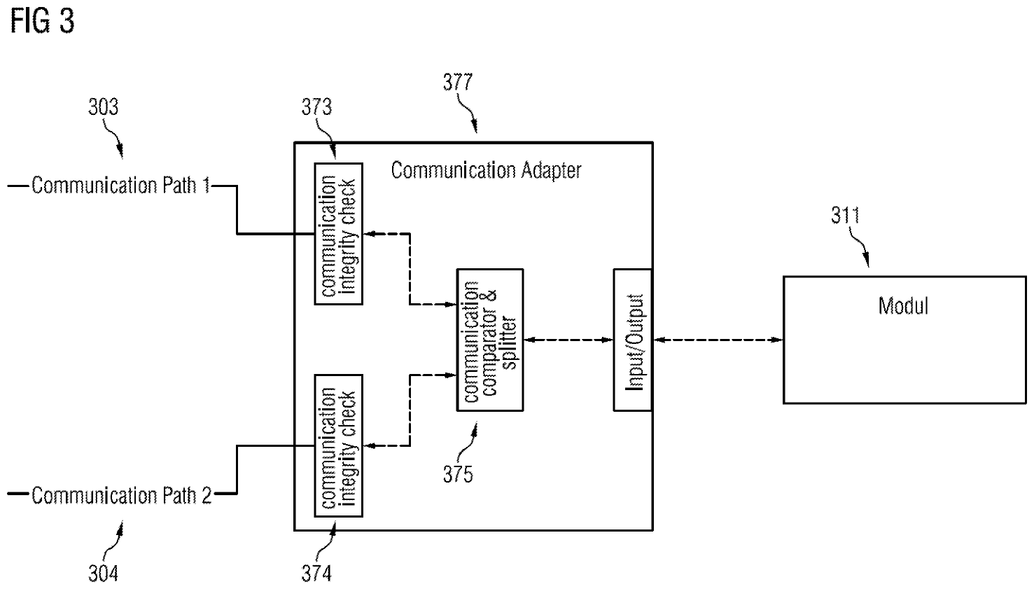

FIG. 3 shows a communication adapter 377 which may be coupled to or integrated in a Power Switch module 311 (denoted with reference sign 140 in FIG. 1). Communication is needed to allow system-wide load balancing, transfer of electrical energy, etc. The exemplary communication adapter allows communication over two paths path1 as 303 and path2 as 304.

The communication integrity check 373, 374 in this example has specific tasks for input and output. On input it checks and acknowledges “heartbeat”, checks timing, verifies the cyclic redundancy code (CRC), and/or schedules the next “heartbeat” signal. On output it sends the scheduled “heartbeat” signal, marks messages with line id, computes a check-sum CRC, and computes Quality-of-Service (QoS) values for the last received message.

The communication comparator and splitter 375 on input compares the data or signals from the main and backup communication paths 303, 304. It selects the path to be used based e.g. on timing or QoS values. On output it splits messages from the module 311 onto the two paths.

The communication adapter 377 can especially be used in order to communicate with a server, with zones, and/or with nodes and/or with other entities, for example entities that are mentioned herein or are not mentioned herein.

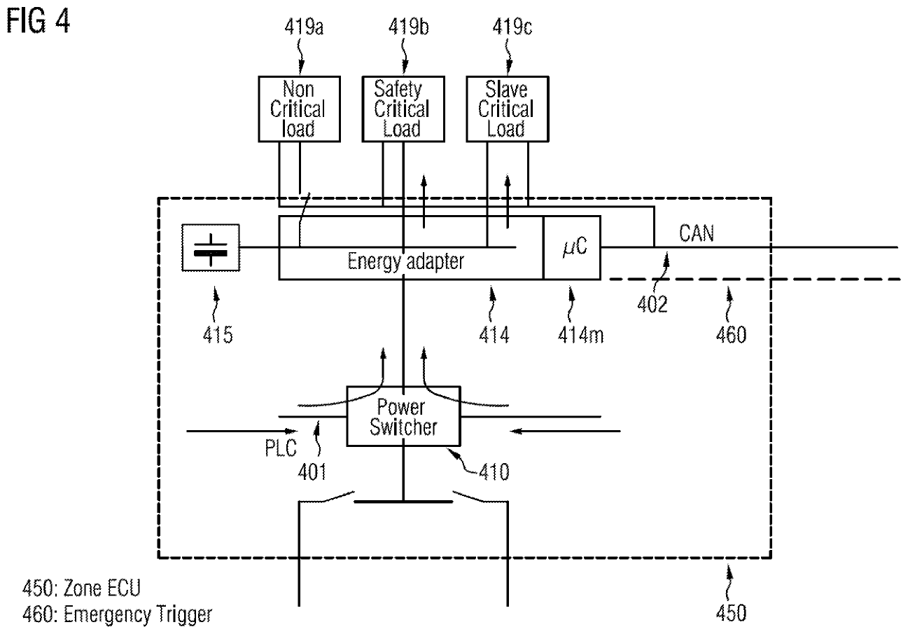

FIG. 4 shows an example configuration of a zone, or a Zone ECU 450, which may be used for a power switch module or a zone 141 as shown in FIG. 1. The Power Switch 410 is connected to a ring power supply 401. The Power Switch has an energy adapter 414 which provides local buffer or storage using a battery 415. The energy adapter is partnered with a microcontroller 414m. Three electrical consumer nodes or loads get power via the energy adapter 414, namely a non-critical load 419a, a safety-critical load 419b, and a slave critical load 419c. All connected consumers can communicate via the CAN bus 402 with the Zone ECU, or the Zone ECU controller 414m. In addition, the Power Switch 410 and Zone ECU can communicate over the ring in both directions using power-line communication (PLC).

In an exemplary implementation, the zone has a communications capability in order to provide redundant communication, using PLC. In another embodiment, a zone may have a specific network connection for fail-operational capability, or may use other communications channels. Heterogenous communication technologies may be used to realize a freedom from interference for functional safety. Especially, bus communication and PLC may be implemented simultaneously. The heterogenous communication channel may also be used as “Emergency trigger” channel.

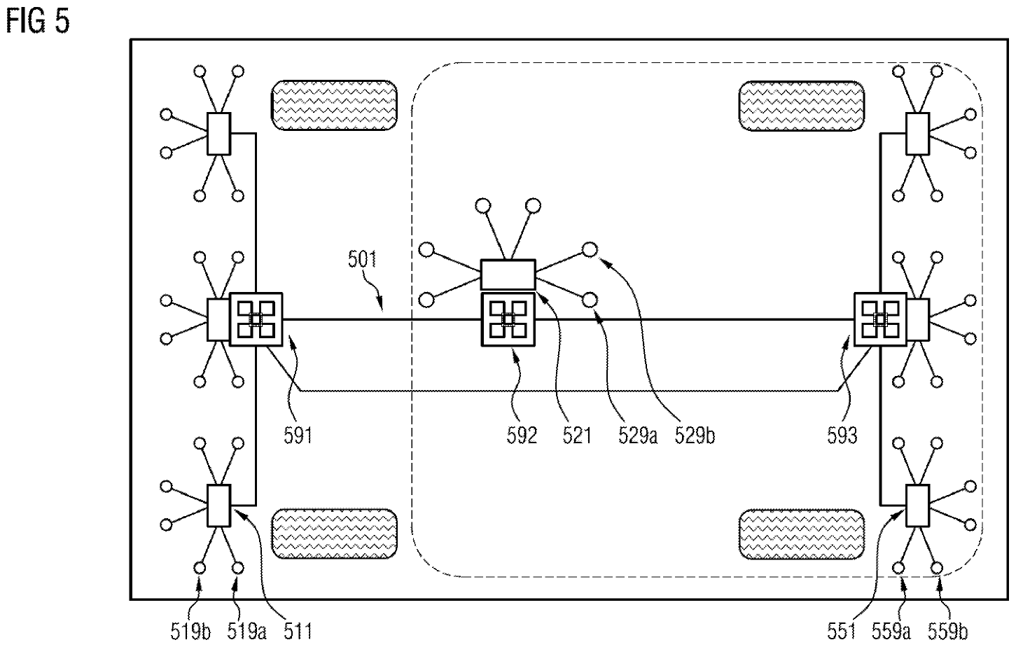

FIG. 5 shows an application to an automotive environment, and also shows a hierarchical structure of zones. Primary Power Switches 591, 592, 593 are connected to the main power supply ring, which supplies power from sources (not shown). Zone ECUs can be connected similarly.

In one aspect of the inventive concept, zones may be hierarchical, and a primary zone may include one or more secondary or sub-zones. The primary Power Switch nodes supply power to secondary Power Switches 511, 521, 551, via supply connections which may or may not be rings. Secondary Power Switches in turn supply power to consumer nodes 519a, 519b, 529a, 529b, 559a, 559b. Primary zones are around primary Power Switches 591, 592, 593, and secondary zones such as that with nodes 519a, 519b are centered around secondary Power Switches such as 511. In the event of partial or complete failure of the power supply network, the Power Switches can be used to redistribute power between nodes of a zone or between zones.

In another aspect of the inventive concept, zones may be dynamically configured into groups or otherwise configured to have functionality which requires coordination of more than one zone. Zones may comprise groups of nodes, being primarily co-located nodes, or nodes with related functionality, or both.

FIG. 6 shows another application to an automotive environment, including normal and back-up communications channels. Zone ECU's 621, 622, 623 and 624 may represent respective zones with one or more nodes 626. Node 625 can be regarded as a stand-alone node, and may not be part of a zone with Zone ECU. Thus, Node 625 is also in direct communication with the server 610. Zones 621 and 623 share a primary communications channel, and zones 622 and 624 have each a primary channel to the server 610. Any one of the nodes 624, 625, 626 may be safety-critical or not safety-critical. All zones share a back-up communications channel 630 (Emergency Line to trigger the execution of last command(s)). In this embodiment, even in the event of a failure in one channel, the server can continue to communicate via the other channel.

The context of a power supply architecture for automotive environments is given as a preferred embodiment. However, it should be clear to the person of skill that the inventive concept can be implemented in other networks and for other environments such as industrial Use Cases.

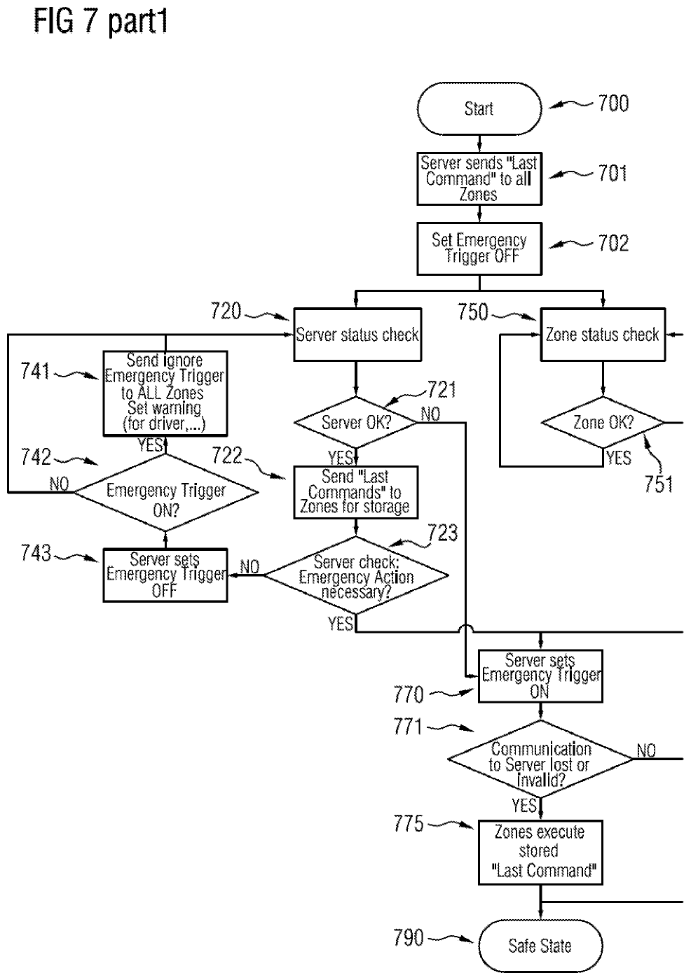

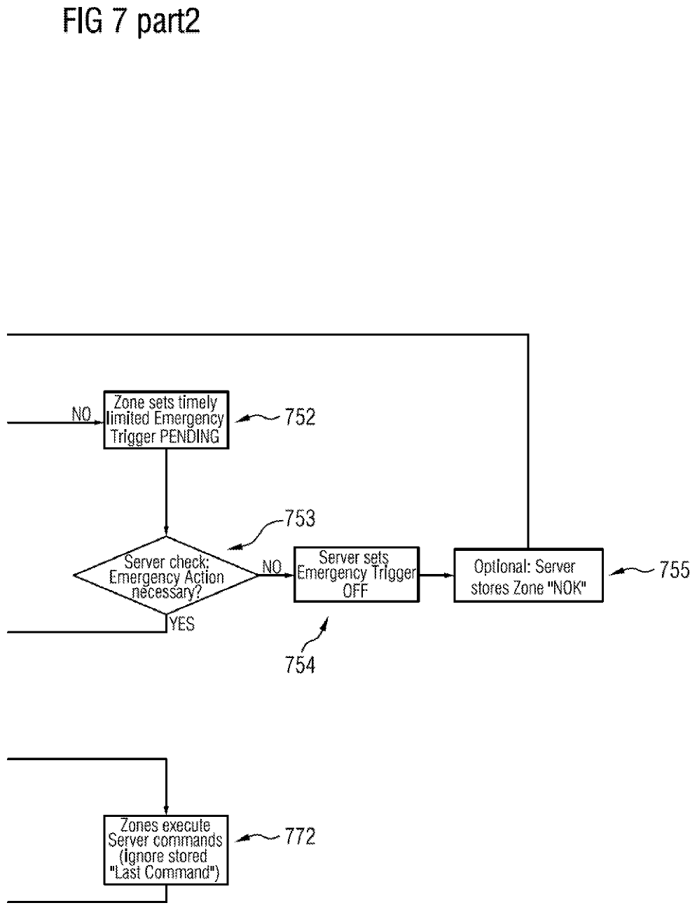

In FIG. 7 are shown steps of an embodiment to mitigate the effects of a power supply failure. In operation, the system starts failure mitigation at step 700. The server sends the “Last Command” to all zones at step 701. The Emergency Trigger is set to starting state (e.g. “OFF”) at step 702.

At step 720, a Server status check is performed. If the result at 721 is no, not OK, then the next step is that the Server sets Emergency Trigger ON. If the result at step 721 is yes, then the next step is 722 to send “Last Commands” to Zones for storage. At step 723 a Server check is needed, to determine whether Emergency Action is necessary. If Yes, then the next step is 770 as above. If no, the Server sets Emergency Trigger OFF at step 743. If the Emergency Trigger is off at step 742 then the system returns to the Server status check at 720; otherwise, if the Trigger is on at step 742, then the next step is to send a message to ignore Emergency trigger to all zones and set a warning message or other indicator of a problem situation.

At step 750 a Zone status check is performed. If the Zone is ok at 751, then the system continues to step 750 and repeats; otherwise the Zone must indicate that the Emergency trigger is pending. At 753 the server checks if Emergency Action is needed. If action is needed, then at step 770 the Server will do the emergency trigger. If the result is no, then at 754 the Server sets Emergency Trigger off, and as an optional step at 755 that the Server stores a signal “NOK” or another marker concerning the Zone in question.

In the following, possible items are given in structured form. They may be regarded as separate aspects of the invention. They may be taken alone, in combination, or in combination with other aspects disclosed herein.
1. An electrical power supply network for a set of power-consuming nodes, grouped in two or more zones,
wherein at least one zone comprises two or more electrical power consuming nodes, and at least one Zone ECU and Power Switch (110, 120, 130, 140, 150) which controls the entry and exit of electrical power to the zone, and
   wherein, in the event of partial or complete failure of the power supply network, power is redistributed between nodes of a zone or between zones.
2. The network of item 1 wherein the electrical connections between nodes are at least in part in the form of a ring.
3. The network of a previous item, wherein the network comprises multiple rings of Power Switches.
4. The network of a previous item, in which in the event of partial or complete failure of the power supply network, Zone ECUs and a central server communicate amongst themselves to determine the redistribution of power.
5. The network of any previous item, in which a central server sends individual “Last Commands” to Zone ECUs and/or standalone nodes.
6. The network of any previous item, in which a central server, Zone ECUs and standalone nodes are connected via an “Emergency Trigger” line.
7. The network of the previous item wherein the “Emergency Trigger” line is at least partly connected as a ring.
8. The network of item 6 or 7, wherein some or all Components connected to the “Emergency trigger” line will execute the “Last Command” action or actions in case of an interrupted communication and ‘Active’ “Emergency Trigger”.
9. The network of a previous item, in which the nodes of a zone execute a Last Command in the event of a failure of the power supply network.
10. The network of a previous item in which at least one zone comprises a local buffer or local electricity store.
11. The network of item 10 wherein the local buffer or local electrical store comprises a battery or a capacitor and/or other electrical supply or storage devices.
12. The network of items 10 or 11 wherein a given zone is configured to, in the event of failure, receive power from the local store of another zone or from recuperation energy from a drive or traction motor.
13. The network of any of items 10 to 12 in which the local buffer or local electricity store is configured to supply additional power for a zone which does not have a local store or insufficient local store.
14. The network of any previous item in which at least one zone comprises a sub-zone.
15. The network of any previous item which is adapted for use in an automotive environment.
16. A method of operating an electrical supply network comprising two or more zones, wherein, in the event of partial or complete failure of the power supply network, power is redistributed between nodes or zones.
17. The method of the previous item wherein, in the event of a failure, the Zone ECU of a zone determines which node or nodes receive power.
18. The method of the previous items 16 or 17 wherein the nodes pass electricity around a ring.
19. The method of items 16 to 18 which is applied, in the event of failure, to reduce peak consumption of local consumers from the central power supply and/or to limit the consumption from the central supply to closer to that of an average load.

Mentioned steps of the inventive method can be performed in the given order. However, they can also be performed in another order, as long as this is technically reasonable. The inventive method can, in an embodiment, for example with a certain combination of steps, be performed in such a way that no further steps are performed. However, also other steps may be performed, including steps that are not mentioned.

It is to be noted that features may be described in combination in the claims and in the description, for example in order to provide for better understandability, despite the fact that these features may be used or implemented independent from each other. The person skilled in the art will note that such features can be combined with other features or feature combinations independent from each other.

References in dependent claims may indicate preferred combinations of the respective features, but do not exclude other feature combinations.

1. An electrical power supply network for a set of power-consuming nodes, comprising two or more zones,
wherein at least one zone comprises two or more electrical power consuming nodes, and at least one Power Switch which controls the entry and exit of electrical power to the zone, and
wherein, in the event of failure of the power supply network, power is redistributed between nodes of a zone and/or between zones.

2. The network of claim 1, wherein one type of failure is a failure in a power source supplying electrical power to the network.

3. The network of claim 1, wherein one type of failure is an interruption of an electrical connection forming the network and/or being part of the network.

4. The network of claim 1, wherein one type of failure is an interruption in communication between nodes and/or between zones.

5. The network of claim 1, wherein power is redistributed by disconnecting one zone, or more than one zone, from the network.

6. The network claim 1, wherein power is redistributed depending on the type of failure.

7. The network claim 1, wherein one or more nodes are standalone nodes not being part of a zone.

8. (canceled)

9. (canceled)

10. (canceled)

11. (canceled)

12. (canceled)

13. The network of claim 1, in which a central server sends individual “Last Commands” to zones, Zone ECUs and/or standalone nodes, wherein a “Last Command” is sent in response to determining at least one type of failure.

14. (canceled)

15. The network of claim 13, wherein a “Last Command” depends on a type of a detected failure.

16. The network of claim 1, in which a central server, zones, Zone ECUs and/or standalone nodes are connected via an “Emergency Trigger” line.

17. (canceled)

18. The network of claim 16, wherein some or all components connected to the “Emergency trigger” line will execute the “Last Command” action or actions in case of an interrupted communication, an interrupted communication over the “Emergency Trigger” line, and/or an active “Emergency Trigger”.

19. (canceled)

20. The network of claim 1, in which the nodes of a zone execute a Last Command in the event of a failure of the power supply network.

21. The network of claim 1, in which at least one zone comprises a local buffer or local electricity store.

22. (canceled)

23. The network of claim 21 wherein a given zone, one zone, or more than one zone, or each zone, is configured to, in the event of failure, receive power from the local buffer or local electricity store of another zone, and/or from recuperation energy from a drive or traction motor.

24. The network of claim 21 in which the local buffer or local electricity store is configured to supply additional power for a zone which does not have a local buffer and/or does not have a local electricity store and/or has an insufficient local store.

25. The network of claim 21, wherein power is redistributed by supplying power from a local buffer and/or a local electricity store to one node or more nodes of the same zone as the local buffer and/or the local electricity store.

26. The network of claim 21, wherein power is redistributed by supplying power from a local buffer and/or a local electricity store to one node of more nodes of a different zone as the local buffer and/or the local electricity store.

27. (canceled)

28. (canceled)

29. A method of operating an electrical supply network comprising two or more zones, wherein, in the event of failure of the power supply network, power is redistributed between nodes of a zone, and/or between zones.

30. The method of claim 29 wherein, in the event of a failure, the Zone ECU of a zone and/or nodes of a zone determine, or communicate amongst themselves and/or with each other to determine, which node or nodes receive power.

31. (canceled)

32. The method of claim 29, wherein, in the event of failure, peak consumption of local consumers from the central power supply is reduced and/or the consumption from the central supply to closer to that of an average load is limited.

33. (canceled)
